(19) United States
(12) Patent Application Publication
(10) Pub. No.: US 2026/0248133 A1
(43) Pub. Date: Aug. 27, 2026

(54) NOVEL AQUEOUS COMPOSITIONS OF DIAMIDES

(71) Applicant: ADAMA MAKHTESHIM LTD., Beer Sheva (IL)

(72) Inventors: Yohai DAYAGI, Kibbutz Kramim (IL); Yogev DAHAN, Tene Omarim (IL)

(73) Assignee: ADAMA MAKHTESHIM LTD., Beer Sheva (IL)

(21) Appl. No.: 18/879,118

(22) PCT Filed: Jun. 29, 2023
(86) PCT No.: PCT/IL2023/050668

§ 371 Date: Dec. 26, 2024

Related U.S. Application Data
(60) Provisional application No. 63/356,501, filed on Jun. 29, 2022.

(51) Int. Cl. A01N 43/56; A01N 25/22; A01N 31/02; A01N 43/36; A01P 7/02; A01P 7/04

(52) U.S. Cl. CPC A01N 43/56; A01N 25/22; A01N 31/02; A01N 43/36; A01P 7/02; A01P 7/04

(57) ABSTRACT

The present invention relates to agrochemical suspension concentrate compositions containing from 1.0% to 40% w/w of diamides, sulfosuccinate salts, non-ionic stabilizers, optionally anionic stabilizers, and use of said agrochemical suspension concentrates as crop protection agents.

### FIELD OF INVENTION

The present invention relates to agrochemical suspension concentrate compositions containing diamides, sulfosuccinate salts and stabilizer and their use as crop protection agents.

### SUMMARY

The present invention is directed to an agrochemical suspension concentrate composition comprising:
a) 1.0-40% w/w of diamide compound
b) Sulfosuccinate salt at a concentration from greater than about 0.2 w/w % to about 10 w/w %
c) Nonionic stabilizer at a concentration from greater than about 0.2 w/w % to about 10 w/w %
d) Optionally at least one anionic stabilizer at a concentration from greater than about 0.5 w/w % to about 10 w/w %
e) Water.

Another aspect of the present invention relates to an agrochemical suspension concentrate composition comprising:
a) 1.0-40% w/w of diamide compound
b) Sulfosuccinate salt at a concentration from greater than about 0.2 w/w % to about 10 w/w %
c) Nonionic stabilizer at a concentration from greater than about 0.2 w/w % to about 10 w/w %
d) Anionic stabilizer at a concentration from greater than about 0.5 w/w % to about 10 w/w %
e) Water

This invention further directed to a method for controlling a pest comprising diluting said suspension concentrate composition with water and optionally adding an adjuvant to form a diluted composition and contacting the pest or its environment with an effective amount of said diluted composition.

### BACKGROUND

Pesticidal active ingredients are used in agrochemical filed in the form of formulations, which are in general purposed to reach better utilization of said active ingredients.

Formulating a pesticide involves preparations to improve pesticide storage, safety, application, and/or effectiveness. Such preparations are generally exist in solid or in liquid form. Liquid pesticide formulations, in principle, commonly have number of advantages: they can be easily measured and poured, and form well sprayed aqueous solutions or dispersions after dilution in water. The following main types of liquid compositions exist: soluble liquid concentrates, in which active ingredient is dissolved in an organic phase, which forms clear solution after dilution in water, emulsion concentrates in which active ingredient is dissolved in an organic oily phase and further emulsified after dilution in water, and suspension concentrates in which solid particles of active ingredients are suspended in a water phase. The suspension concentrates are aqueous-based concentrates which have the added advantage of not requiring the use of organic solvents, present in emulsifiable concentrates and soluble liquid concentrates. However, while emulsifiable concentrates and soluble liquid concentrates are monophase systems, aqueous suspension concentrates of solid active substances are two-phase systems (solid/liquid), which generally are less stable and tend to separation; this tendency increasing with increasing storage time and storage temperature. A major requirement for preparation of stable suspension concentrates is selection of a proper surfactant system which physically stabilize the active organic solid in water.

Even supposing that theories on the conditions for the formation of stable suspensions exist, it is impossible to set directly best possible formulation surfactant system in case of different solid active ingredients due to the large number of criteria to be taken into consideration. Therefore, there is a need for new optimal surfactants system leading to formation of stable suspension concentrates having improved bioefficacy on agrochemical applications.

### DETAILED DESCRIPTION OF INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

The term “stabilizer” as used herein refers but not limited to a chemical agent that is added to a composition and exhibiting a satisfactory stabilization effect on the combination of other inert and active ingredient/s contained in the present agricultural chemical composition, without any adverse influence on the physical properties of the composition.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “suspension concentrate composition” refers to compositions comprising finely divided solid particles of an active ingredient/s dispersed in water or organic liquid. Said particles preserve chemical and physical identity and can be physically separated from liquid.

As used herein, the term “insecticide” broadly refers to compounds or compositions that are used as acaricides, insecticides, insecticide synergists, ixodicides, nematicides, and molluscicides. For chemical classes and applications, as well as specific compounds of each class, see “The Pesticide Manual Thirteenth Edition” (British Crop Protection Council, Hampshire, UK, 2003), as well as “The e-Pesticide Manual, Version 3” (British Crop Protection Council, Hampshire, UK, 2003-04), the contents of each of which are incorporated herein by reference in their entirety.

As used herein the term “plant” or “crop” refers, but is not limited to whole plants, plant organs (e.g. leaves, stems, twigs, roots, trunks, limbs, shoots, fruits etc.), plant cells, or plant seeds. This term also encompasses plant crops such as fruits and vegetables. In some embodiments, the term “plant” may include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein the term “plant propagation material” refers, but is not limited to, all the generative parts of the plant such as seeds and vegetative plant material such as cuttings and tubers, which can be used for the multiplication of the plant including tubers, spores, corms, bulbs, rhizomes, sprouts basal shoots, stolons, and buds and other parts of plants, including seedlings and young plants, which are to be transplanted after germination or after emergence from soil.

As used herein, the term “locus” refers, but is not limited to the place on which the plants are growing, the place on which the plant propagation materials of the plants are sown or the place on which the plant propagation materials of the plants will be sown including the areas under cultivation.

As used herein, the term “treating a plant or a locus against insect and/or mite pest” includes, but is not limited to, protecting the plant or locus against insect and/or mite pest and/or controlling insect and/or mite pest of the plant or locus.

As used herein the term “ha” refers to hectare.

As used herein, the term “mixture” or “combination” refers, but is not limited to, a combination in any physical form, e.g., blend, solution, suspension or the like.

### BRIEF DESCRIPTION OF THE FIGURES

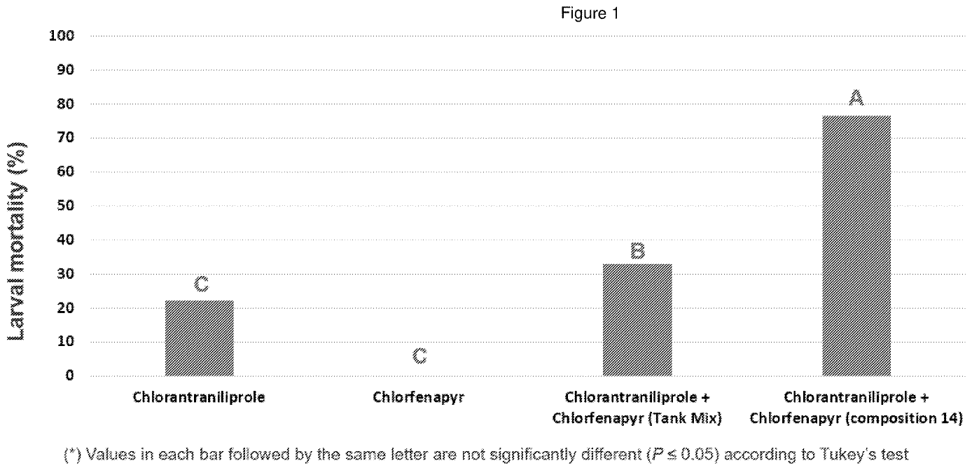

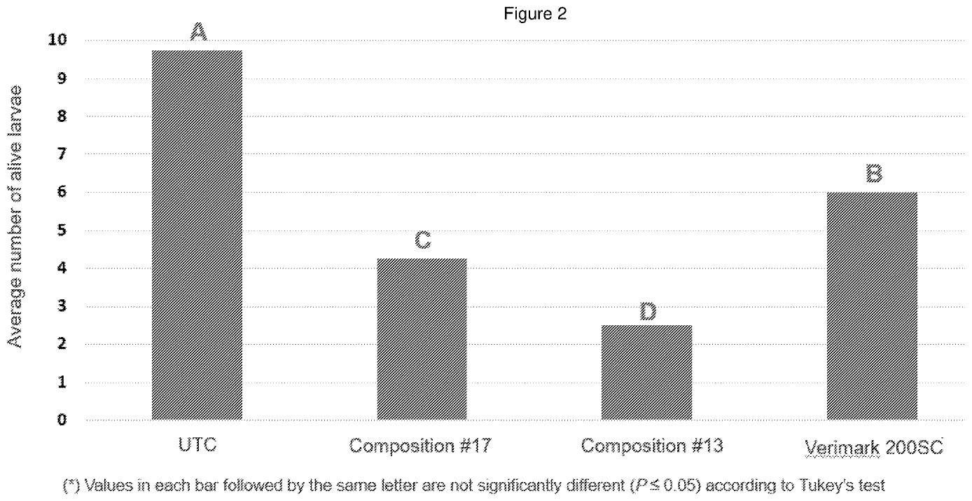

1) Insecticidal efficacy (%) of different Chlorantraniliprole compositions calculated based on S. littoralis larval mortality assessment three days after larval infestation is represented on FIG. 1.
2) Insecticidal efficacy of different Cyantraniliprole compositions based on number of S. littoralis alive larvae three days after infestation is represented on FIG. 2.

### The Agrochemical Composition Subject of Invention:

The present invention provides an agrochemical suspension concentrate composition comprising: a) 1.0-40% w/w of diamide compound, b) sulfosuccinate salt at a concentration from greater than about 0.2 w/w % to about 10 w/w %, c) nonionic stabilizer at a concentration from greater than about 0.2 w/w % to about 10 w/w %, d) optionally at least one anionic stabilizer at a concentration from greater than about 0.5 w/w % to about 10 w/w %, e) water.

In some embodiments, the agrochemical suspension concentrate composition comprises a) diamide compound at a concentration from about 30 w/w % to about 40 w/w % b) sulfosuccinate salt at a concentration from greater than about 0.2 w/w % to about 10 w/w %, c) nonionic stabilizer at a concentration from greater than about 0.2 w/w % to about 10 w/w %, d) optionally at least one anionic stabilizer at a concentration from greater than about 0.5 w/w % to about 10 w/w %; e) water.

In some embodiments, the agrochemical suspension concentrate composition comprises a) diamide compound at a concentration from about 25 w/w % to about 35 w/w % b) sulfosuccinate salt at a concentration from greater than about 0.2 w/w % to about 10 w/w %, c) nonionic stabilizer at a concentration from greater than about 0.2 w/w % to about 10 w/w %, d) optionally at least one anionic stabilizer at a concentration from greater than about 0.5 w/w % to about 10 w/w %; e) water.

In another embodiments, the agrochemical suspension concentrate composition comprises a) diamide compound at a concentration from about 20 w/w % to about 30 w/w %, b) sulfosuccinate salt at a concentration from greater than about 0.2 w/w % to about 10 w/w %, c) nonionic stabilizer at a concentration from greater than about 0.2 w/w % to about 10 w/w %, d) optionally at least one anionic stabilizer at a concentration from greater than about 0.5 w/w % to about 10 w/w %; e) water.

In some embodiments, the agrochemical suspension concentrate composition comprises a) diamide compound at a concentration from about 10.0 w/w % to about 20 w/w %, b) sulfosuccinate salt at a concentration from greater than about 0.2 w/w % to about 10 w/w %, c) nonionic stabilizer at a concentration from greater than about 0.2 w/w % to about 10 w/w %, d) optionally at least one anionic stabilizer at a concentration from greater than about 0.5 w/w % to about 10 w/w %; e) water.

In some embodiments, the agrochemical suspension concentrate composition comprises a) diamide compound at a concentration from about 1.0 w/w % to about 10 w/w %, b) sulfosuccinate salt at a concentration from greater than about 0.2 w/w % to about 10 w/w %, c) nonionic stabilizer at a concentration from greater than about 0.2 w/w % to about 10 w/w %, d) optionally at least one anionic stabilizer at a concentration from greater than about 0.5 w/w % to about 10 w/w %; e) water.

The present invention also provides an agrochemical suspension concentrate composition comprising: 1.0-40% w/w of diamide compound, b) sulfosuccinate salt at a concentration from greater than about 0.2 w/w % to about 10 w/w %, c) nonionic stabilizer at a concentration from greater than about 0.2 w/w % to about 10 w/w %, d) anionic stabilizer at a concentration from greater than about 0.5 w/w % to about 10 w/w %, e) water.

In some embodiments, the agrochemical suspension concentrate composition comprises a) diamide compound at a concentration from about 25 w/w % to about 35 w/w % b) sulfosuccinate salt at a concentration from greater than about 0.2 w/w % to about 10 w/w %, c) nonionic stabilizer at a concentration from greater than about 0.2 w/w % to about 10 w/w %, d) anionic stabilizer at a concentration from greater than about 0.5 w/w % to about 10 w/w %; e) water.

In some embodiments, the agrochemical suspension concentrate composition comprises a) diamide compound at a concentration from about 30 w/w % to about 40 w/w % b) sulfosuccinate salt at a concentration from greater than about 0.2 w/w % to about 10 w/w %, c) nonionic stabilizer at a concentration from greater than about 0.2 w/w % to about 10 w/w %, d) anionic stabilizer at a concentration from greater than about 0.5 w/w % to about 10 w/w %; e) water.

In another embodiments, the agrochemical suspension concentrate composition comprises: a) diamide compound at a concentration from about 20 w/w % to about 30 w/w %, b) sulfosuccinate salt at a concentration from greater than about 0.2 w/w % to about 10 w/w %, c) nonionic stabilizer at a concentration from greater than about 0.2 w/w % to about 10 w/w %, d) anionic stabilizer at a concentration from greater than about 0.5 w/w % to about 10 w/w %; e) water.

In some embodiments, the agrochemical suspension concentrate composition comprises a) diamide compound at a concentration from about 10 w/w % to about 20 w/w %, b) sulfosuccinate salt at a concentration from greater than about 0.2 w/w % to about 10 w/w %, c) nonionic stabilizer at a concentration from greater than about 0.2 w/w % to about 10 w/w %, d) anionic stabilizer at a concentration from greater than about 0.5 w/w % to about 10 w/w %; e) water.

In some embodiments, the agrochemical suspension concentrate composition comprises a) diamide compound at a concentration from about 1.0 w/w % to about 10 w/w %, b) sulfosuccinate salt at a concentration from greater than about 0.2 w/w % to about 10 w/w %, c) nonionic stabilizer at a concentration from greater than about 0.2 w/w % to about 10 w/w %, d) anionic stabilizer at a concentration from greater than about 0.5 w/w % to about 10 w/w %; e) water.

In some embodiments the diamide compound is selected from chlorantraniliprole, cyantraniliprole, tetrachlorantraniliprole, bromoantraniliprole, dichlorantraniliprole, tetraniliprole, cyclaniliprole, cyhalodiamide, flubendiamide, and combinations thereof.

In some embodiments the diamide compound is chlorantraniliprole.

In some embodiments the diamide compound is cyantraniliprole.

In an embodiment, the agrochemical suspension concentrate composition comprises nonionic stabilizer selected from EO-PO block copolymers, acrylate copolymers, styrene (meth)acrylic copolymers, poloxamers, fatty alcohol alkoxylates and the mixtures thereof.

In some embodiment, the agrochemical suspension concentrate composition comprises anionic stabilizer selected from naphthalene sulfonate derivatives, lignosulfonate derivatives, polycarboxylates, fatty alcohol phosphate esters, aryl phenol alkoxylate phosphate esters, aryl phenol alkoxylate sulfate esters, salts of vinyl ether polymers and the mixtures thereof.

In an embodiment, the weight ratio of sulfosuccinate salt to the nonionic stabilizer is from about 1:15 to about 15:1.

In an embodiment, the weight ratio of sulfosuccinate salt to the nonionic stabilizer is from about 1:10 to about 10:1.

In an embodiment, the weight ratio of sulfosuccinate salt to the nonionic stabilizer is from about 1:8 to about 8:1.

In an embodiment, the weight ratio of sulfosuccinate salt to the nonionic stabilizer is from about 1:5 to about 5:1.

In an embodiment, the weight ratio of sulfosuccinate salt to the nonionic stabilizer is from about 1:3 to about 3:1.

In an embodiment, the weight ratio of sulfosuccinate salt to the nonionic stabilizer is from about 1:2 to about 2:1.

In an embodiment, the weight ratio of sulfosuccinate salt to the nonionic stabilizer is about 1:1.

In some embodiment, the weight ratio of sulfosuccinate salt to the anionic stabilizer is from about 1:15 to about 15:1.

In some embodiment, the weight ratio of sulfosuccinate salt to the anionic stabilizer is from about 1:12 to about 12:1.

In some embodiment, the weight ratio of sulfosuccinate salt to the anionic stabilizer is from about 1:10 to about 10:1.

In some embodiment, the weight ratio of sulfosuccinate salt to the anionic stabilizer is from about 1:8 to about 8:1.

In some embodiment, the weight ratio of sulfosuccinate salt to the anionic stabilizer is from about 1:6 to about 6:1.

In some embodiment, the weight ratio of sulfosuccinate salt to the anionic stabilizer is from about 1:5 to about 5:1.

In some embodiment, the weight ratio of sulfosuccinate salt to the anionic stabilizer is from about 1:3 to about 3:1.

In some embodiment, the weight ratio of sulfosuccinate salt to the anionic stabilizer is from about 1:2 to about 2:1.

In some embodiment, the weight ratio of sulfosuccinate salt to the anionic stabilizer is about 1:1.

In some embodiments, the amount of the diamide compound in the composition is about 1-400 g/L. In some embodiments, the amount of the diamide compound in the composition is about 300-400 g/L. In some embodiments, the amount of the diamide compound in the composition is about 100-400 g/L.

In some embodiments, the amount of the diamide compound in the composition is about 100-300 g/L.

In some embodiments, the amount of the diamide compound in the composition is about 1-100 g/L.

In some embodiments, the amount of the diamide compound in the composition is about 50-150 g/L.

In some embodiments, the amount of the diamide compound in the composition is about 1-50 g/L. In some embodiments, the amount of the diamide compound in the composition is about 1-30 g/L. In some embodiments, the amount of the diamide compound in the composition is about 1-10 g/L.

In some embodiments the amount of sulfosuccinate salt is from about 0.2 w/w % to about 10.0 w/w %. In some embodiments the amount of sulfosuccinate salt is from about 0.2 w/w % to about 1.0 w/w %. In some embodiments the amount of sulfosuccinate salt is from about 0.5 w/w % to about 1.5 w/w %. In some embodiments the amount of sulfosuccinate salt is from about 1.0 w/w % to about 5.0 w/w %. In some embodiments the amount of sulfosuccinate salt is from about 1.5 w/w % to about 3.0 w/w %.

In some embodiments the amount of the nonionic stabilizer is from about 0.5 w/w % to about 10 w/w %. In some embodiments the amount of the nonionic stabilizer is from about 0.5 w/w % to about 1.5 w/w %. In some embodiments the amount of the nonionic stabilizer is from about 1.5 w/w % to about 3.5 w/w %. In some embodiments the amount of the nonionic stabilizer is from about 1.0 w/w % to about 5.0 w/w %. In some embodiments the amount of the nonionic stabilizer is from about 3.0 w/w % to about 5.0 w/w %. In some embodiments the amount of the nonionic stabilizer is from about 5.0 w/w % to about 10 w/w %.

In some embodiments the amount of the anionic stabilizer is from about 0.5 w/w % to about 10.0 w/w %. In some embodiments the amount of the anionic stabilizer is from about 0.5 w/w % to about 5.0 w/w %. In some embodiments the amount of the anionic stabilizer is from about 0.5 w/w % to about 3.0 w/w %. In some embodiments the amount of the anionic stabilizer is from about 1.0 w/w % to about 5.0 w/w %. In some embodiments the amount of the anionic stabilizer is from about 1.0 w/w % to about 3.0 w/w %. In some embodiments the amount of the anionic stabilizer is from about 3.0 w/w % to about 6.0 w/w %. In some embodiments the amount of the anionic stabilizer is from about 5.0 w/w % to about 10.0 w/w %.

In an embodiment, the weight ratio of diamide compound to sulfosuccinate salt is from about 1:1 to about 35:1.

In an embodiment, the weight ratio of diamide compound to sulfosuccinate salt is from about 25:1 to about 35:1.

In an embodiment, the weight ratio of diamide compound to sulfosuccinate salt is from about 20:1 to about 35:1.

In an embodiment, the weight ratio of diamide compound to sulfosuccinate salt is from about 15:1 to about 35:1.

In an embodiment, the weight ratio of diamide compound to sulfosuccinate salt is from about 10:1 to about 35:1.

In an embodiment, the weight ratio of diamide compound to sulfosuccinate salt is from about 5:1 to about 35:1.

In an embodiment, the weight ratio of diamide compound to sulfosuccinate salt is from about 1:1 to about 25:1.

In an embodiment, the weight ratio of diamide compound to sulfosuccinate salt is from about 1:1 to about 20:1.

In an embodiment, the weight ratio of diamide compound to sulfosuccinate salt is from about 1:1 to about 10:1.

In an embodiment, the weight ratio of diamide compound to sulfosuccinate salt is from about 1:1 to about 5:1.

In an embodiment, the weight ratio of diamide compound to sulfosuccinate salt is from about 1:1 to about 3:1.

In an embodiment, the weight ratio of diamide compound to sulfosuccinate salt is from about 1:1 to about 2:1.

In an embodiment, the agrochemical suspension concentrate composition further comprises an additional pesticidal active ingredient selected from chlorfenapyr, novaluron, flupyrimin, methoxyfenozide.

In an embodiment, the amount of an additional pesticidal active ingredient is from 1.0 to 40% per weight of total composition.

In another embodiment, the amount of an additional pesticidal active ingredient is from 30 to 40% per weight of total composition.

In an embodiment, the amount of an additional pesticidal active ingredient is from 20 to 40% per weight of total composition.

In another embodiment, the amount of an additional pesticidal active ingredient is from 10 to 30% per weight of total composition.

In another embodiment, the amount of an additional pesticidal active ingredient is from 5.0 to 20% per weight of total composition.

In another embodiment, the amount of an additional pesticidal active ingredient is from 5.0 to 10% per weight of total composition.

In an embodiment, the amount of an additional pesticidal active ingredient is from 1.0 to 5.0% per weight of total composition.

In another embodiment, the ratio between diamide insecticide and an additional pesticidal active ingredient is from 1:8 to 8:1.

In another embodiment the ratio between chlorantraniliprole and an additional pesticidal active ingredient is from about 1:8 to 8:1.

In another embodiment the ratio between chlorantraniliprole and an additional pesticidal active ingredient is from about 1:5 to 5:1.

In another embodiment the ratio between chlorantraniliprole and an additional pesticidal active ingredient is from about 1:3 to 3:1.

In another embodiment the ratio between chlorantraniliprole and an additional pesticidal active ingredient is from about 1:2 to 2:1.

In another embodiment the ratio between chlorantraniliprole and an additional pesticidal active ingredient is from about 1:1.5 to 1.5:1.

In another embodiment the ratio between cyantraniliprole and an additional pesticidal active ingredient is from about 1:8 to 8:1.

In another embodiment the ratio between cyantraniliprole and an additional pesticidal active ingredient is from about 1:5 to 5:1.

In another embodiment the ratio between cyantraniliprole and an additional pesticidal active ingredient is from about 1:3 to 3:1.

In another embodiment the ratio between cyantraniliprole and an additional pesticidal active ingredient is from about 1:2 to 2:1.

In another embodiment the ratio between cyantraniliprole and an additional pesticidal active ingredient is from about 1:1.5 to 1.5:1.

In an embodiment, the agrochemical suspension concentrate composition comprises chlorantraniliprole and chlorfenapyr.

In an embodiment, the agrochemical suspension concentrate composition comprises chlorantraniliprole and flupyrimin.

In an embodiment, the agrochemical suspension concentrate composition comprises chlorantraniliprole.

In an embodiment, the agrochemical suspension concentrate composition comprises chlorantraniliprole and novaluron.

In an embodiment, the agrochemical suspension concentrate composition comprises cyantraniliprole and chlorfenapyr.

In an embodiment, the agrochemical suspension concentrate composition comprises cyantraniliprole and flupyrimin.

In an embodiment, the agrochemical suspension concentrate composition comprises cyantraniliprole and methoxyfenozide.

In an embodiment, the agrochemical suspension concentrate composition comprises cyantraniliprole and novaluron.

In certain embodiments, agrochemical suspension concentrate composition of the invention, as defined according to any one of the embodiments above, further comprises an anti-foaming agent.

The term “anti-foaming agent” as used herein refers to a chemical agent that is added to a composition so as to prevent, attenuate, or counter foam generation in the composition. Generally, such agents have surface active properties, are insoluble in the foaming medium, easily spreadable on the foamy surface, possess affinity to the air-liquid surface, and destabilize the foam lamellas which rupture the air bubbles and break down the surface foam.

Non-limiting examples of anti-foaming agents include a mixture of alkenes, C11-C12, hydroformylation products, low boiling, or a commercially available product comprising it such as Geronol AF 80; a mineral oil-based defoamer or a commercially available product comprising it such as Lucrafoam® PDT; a blend of special wax, hydrophobic silica, and mineral oil or a commercially available product comprising it such as DEE FO® 3010E/50; a silicon emulsion or a commercially available product comprising it such as Silfoam® SE 47, Silfoam® SRE, Silcolapse® RG 12, Silcolapse® 432, Silcolapse® 416, and SAG 1572; a polydimethyl siloxane emulsion or a commercially available product comprising it such as SAG 10E; or a silicone-based compound or a commercially available product comprising it such as Silcolapse™ 910 and Xiameter® ACP-1000.

In certain embodiments, the anti-foaming agent comprised within the composition of the invention constitutes from about 0.1% to about 3%, e.g., from about 0.75% to about 2.5%, from about 1% to about 2%, from about 1.25% to about 1.75%, or about 1.5%, by weight of said composition.

In certain embodiments, agrochemical suspension concentrate composition of the invention, as defined according to any one of the embodiments above, further comprises an anti-freeze agent.

Non-limiting examples of anti-freeze agents include (such as but not limited to glycerine, ethylene glycol, propylene glycol, monopropylene glycol, hexylene glycol, 1-methoxy-2-propanol, cyclohexanol).

In certain embodiments, the anti-freeze agent comprised within the composition of the invention constitutes from about 3% to about 10%, by weight of said composition.

In an embodiment, the volume mean diameter of the solid particles present in the agrochemical suspension concentrate composition of the invention is less than 15 μm, more preferably from about 1 μm to 14 μm, and most preferably from about 3 μm to 13 μm.

In another embodiment, the volume mean diameter of the solid particles present in the agrochemical suspension concentrate composition of the invention is from about 2 μm to 10 μm.

### Methods of Preparation and Applying of Agrochemical Composition:

Methods for making agrochemical suspension concentrate compositions are well known in the art and include ball-milling, bead-milling, sand-milling, colloid milling and air-milling combined with high-speed blending. The listed methods can be used in the preparation of the compositions of the present invention. This invention also relates to a method for controlling a pest comprising diluting said suspension composition with water and contacting the pest or its environment with an effective amount of said diluted composition. The preferred method for applying the diluted compositions of the present invention, such as spraying, atomizing, dispersing or pouring, will depend on the desired objectives and the given circumstances, and can be readily determined by one skilled in the art.

In certain embodiments, agrochemical suspension concentrate composition of the invention, as defined according to any one of the embodiments above used for a method for controlling an arthropod pest, comprising diluting a suspension concentrate composition with water, and optionally adding an adjuvant to form a diluted composition, and contacting the arthropod pest or its environment with an effective amount of said diluted composition.

Adjuvants are auxiliaries, which are added to agricultural compositions so as to increase the effectiveness of one or more of the pesticidal active agents comprised therein, e.g., a herbicide, insecticide, and/or fungicide. The increase in the efficacy of said agrochemical agent induced by the presence of said adjuvant may be due to several possible modes of action such as facilitated wetting, penetration, or better retention.

In an embodiment the adjuvant is selected from Tween 20, SK oil, Silwet L-77, Synergen GA, Tween 22. Tween 23, Tween 24, Synergen GL5, Agnique PG 8107-BL, Atplus UEP 100.

In a particular aspect, the present invention discloses a method of controlling pest comprising applying to a locus where control of said pest is desired an effective amount of the suspension concentrate composition as defined in any one of the embodiments above.

In some embodiments, a pest is a plant pest. In some embodiments, said pest is referred to an insect pest selected from Lepidoptera, Coleoptera, Isoptera, Hemiptera, Orthoptera, Thysanoptera and Diptera species.

In an embodiment, the target pest belongs to Acarina pest (e.g. mites).

In particular, Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), Chistocerca gregaria, Scudderia furcata (forktailed bush katydid) and Valanga nigricorni.

Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

Acarina, such as Acarus siro, Aceria spp., Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus spp., Eurytetranychus spp., Eriophyes spp., Hyalomma spp., Ixodes spp., Nalepella spp., Olygonychus spp., Ornithodoros spp., Panonychus spp., Phyllocoptruta oleivora, Phytonemus spp., Polyphagotarsonemus latus, Psoroptes spp., Rhipicephalus spp., Rhizoglyphus spp., Sarcoptes spp., Tarsonemus spp., Tetranychus spp. and Vasates spp.

In another particular aspect, the present invention discloses a method for the protection of plant propagation material from the attack by a pest such as an insect and/or mite, comprising treating the propagation material or the site where the propagation material is to be planted with an effective amount of suspension concentrate composition as defined herein.

The term “locus” as used herein refers not only to areas where the pest such as an insect and/or mite may already be developed, but also to areas that have not yet been attacked by said pest, and to areas under cultivation. Locus includes the crop and propagation material of the crop (all the generative parts of the crop such as seeds and vegetative plant material such as cuttings and tubers, which can be used for the multiplication of the plant. Examples of propagation material of the crop include seeds, tubers, spores, corms, bulbs, rhizomes, sprouts basal shoots, stolons, buds and other parts of plants, including seedlings and young plants, which could be transplanted after germination or after emergence from soil. Locus also includes the area surrounding the crop and the growing media of the crop, such as soil and crop field.

In certain embodiments, the locus treated by the method disclosed herein above is a field of crop. The term “crop” (or “plant”) as used herein refers to whole plants, plant organs (e.g., leaves, stems, twigs, roots, trunks, limbs, shoots, fruits, etc.), plant cells, or plant seeds. Non-limiting examples of crops are oilseed rape (e.g. canola), cotton, rice, banana, potato (including sweet potato), coffee, sugar cane, citrus, beans, sunflower, corn, soybean, wheat, barley, oats, chickpeas, fruit trees, nut trees (e.g. almonds), lentils, grain sorghum, alfalfa, brassicas, fruiting vegetables (e.g. tomatoes, pepper, chili, eggplant, cucumber, squash etc.), tea, bulb vegetables (e.g. onion, leek etc.), grapes, pome fruit (e.g. apples, pears etc.), and stone fruit (e.g. pears, plums etc.) The present invention will now be illustrated by the following non-limiting Examples.

### EXAMPLES

All amounts of ingredients in the following Examples are represented as percentage of weight by total weight of the composition.

### Example 1: Preparation of Cyantraniliprole SC Compositions

TABLE 1
Inventive compositions #1-#6 comprising Cyantranilprole.

| | Comp. #1 | Comp. #2 | Comp. #3 | Comp. #4 | Comp. #5 | Comp. #6 |
|---|---|---|---|---|---|---|
| Materials | w/w % | w/w % | w/w % | w/w % | w/w % | w/w % |
| Cyantraniliprole | 26.09% | 26.09% | 26.09% | 26.09% | 33.9% | 34.48% |
| tech | | | | | | |
| AG RH 23 | 0.2% | 0.2% | 0.26% | 0.26% | 0.22% | 0.22% |
| Atlox 4913-LQ− | — | — | — | 3% | — | — |
| (MV) | | | | | | |
| EMCOL 4500* | 1% | 1% | 1% | 1% | 1% | 1% |
| Antarox B/848 | 2% | 2% | 2% | 2% | 2% | 2% |
| Morwet D-809 | 3% | 3% | — | — | 3% | 3% |
| Powder | | | | | | |
| Tergitol 15-S-7 | 2% | 2% | 2% | 2% | 1% | 1% |
| Gerapon MAI | — | — | 3% | — | — | — |
| Proxel GXL | 0.12% | 0.12% | 0.1% | 0.1% | 0.02% | 0.13% |
| Propylene | 8% | 8% | 8% | 8% | 8% | 8% |
| Glycol | | | | | | |
| Silcolapse 432 | — | — | 1% | 1% | 0.5% | 0.11% |
| SAG 1572 | 0.05% | 0.05% | — | — | — | — |
| SAG 1538 | 0.05% | 0.05% | — | — | — | — |
| Van Gel B | 0.5% | 0.5% | 0.5% | 0.5% | 0.45% | 0.45% |
| Tween 20 | — | 5% | — | — | 5% | — |
| Silwet L-77 | 3% | — | — | — | — | — |
| SK Enspray 99 | 15% | — | — | — | — | — |
| Water | Qs. To | Qs. To | Qs. To | Qs. To | Qs. To | Qs. To |
| | 100% | 100% | 100% | 100% | 100% | 100% |

*Lankropol KO2 could be used instead of Emcol 4500

TABLE 2
Inventive compositions #12, #13, #17-#19 comprising Cyantraniliprole.

| | Comp. #12 | Comp. #13 | Comp. #17 | Comp. #18 | Comp. #19 |
|---|---|---|---|---|---|
| Materials | w/w % | w/w % | w/w % | w/w % | w/w % |
| Cyantraniliprole tech | 34.48% | 34.48% | 26.09% | 34.48% | 34.48% |
| AG RH 23 | 0.25% | 0.25% | 0.2% | 0.22% | 0.25% |
| Atlox 4913-LQ-(MV) | 3% | 3% | — | — | — |
| EMCOL 4500* | 1% | 1% | 1% | 1% | 1% |
| Antarox B/848 | 1.5% | 1.5% | 2% | 2% | 2% |
| Morwet D-425 Powder | — | — | — | — | — |
| Tergitol 15-S-7 | 2% | 2% | 2% | 1% | 1% |
| Proxel GXL | 0.1% | 0.1% | 0.12% | — | — |
| Propylene Glycol | 8% | 8% | 8% | 8% | 8% |
| Silcolapse 432 | 1% | 1% | — | 0.11% | 1% |
| SAG 1572 | — | — | 0.05% | — | — |
| SAG 1538 | — | — | 0.05% | — | — |
| Van Gel B | 0.5% | 0.5% | 0.5% | 0.55% | 0.5% |
| Tween 20 | — | 5% | 5% | — | 5% |
| Water | Qs. To 100% | Qs. To 100% | Qs. To 100% | Qs. To 100% | Qs. To 100% |

*Lankropol KO2 could be used instead of Emcol 4500

### Example 2. Preparation of Chlorantraniliprole SC Compositions

TABLE 3
Inventive compositions #7-#11, #14-#16 comprising Chlorantraniliprole.

| | Comp. | Comp. | Comp. | Comp. | Comp. | Comp. | Comp. | Comp. |
|---|---|---|---|---|---|---|---|---|
| | #7 | #8 | # 9 | # 10 | # 11 | #14 | #15 | # 16 |
| Materials | w/w % | w/w % | w/w % | w/w % | w/w % | w/w % | w/w % | w/w % |
| Chlorantraniliprole | 6% | 2.25% | 2.25%% | 2.25% | 2.25% | 2.3% | 2.25% | 2.25% |
| tech | | | | | | | | |
| Chlorfenapyr | 20% | 16.22% | 16.22% | 16.22% | 16.22% | 16.55% | 16.22% | 16.22% |
| tech | | | | | | | | |
| AG RH 23 | 0.23% | 0.3% | 0.3% | 0.3% | 0.3% | 0.3% | 0.3% | 0.3% |
| Atlox 4913-LQ(MV) | 3.5% | — | — | — | — | 3.5% | — | — |
| EMCOL 4500 | 1.5% | 0.5% | 0.5% | 1.01% | 0.5% | 1.5% | 1% | 1% |
| Ethylan NS | | 0.5% | 0.5% | 0.5% | 1.5% | | 0.3% | 0.5% |
| 500 LQ | | | | | | | | |
| Morwet D-425 | | 6% | 4% | 6% | — | — | 4% | 4% |
| Powder | | | | | | | | |
| Proxel GXL | 0.023% | 0.07% | 0.07% | 0.07% | 0.07% | 0.07% | 0.07% | 0.07% |
| Glycerine | — | 5% | 5% | 5% | 5% | 6.5% | 5% | 5% |
| Propylene | 6.5% | — | — | — | — | — | — | — |
| Glycol | | | | | | | | |
| Silcolapse 432 | 1.3% | — | — | — | — | 0.65% | — | — |
| SAG 1572 | | 1.41% | 1.41% | 1.41% | 1.41% | | 1.41% | 1.41% |
| Van Gel B | 1.5% | 1.5% | 1.5% | 1.5% | 1.5% | 1.5% | 1.5% | 1.5% |
| Water | Qs. To | Qs. To | Qs. To | Qs. To | Qs. To | Qs. To | Qs. To | Qs. To |
| | 100% | 100% | 100% | 100% | 100% | 100% | 100% | 100% |

### General Preparation Procedure for Examples 1, 2:

All compositions #1-#19 represented above in Tables 1-3 were prepared according to the following procedure:
1. Soft water and Van Gel® B were charged into the vessel and the obtained mixture was stirred by means of shearing for 1 hour.
2. Nonionic stabilizers, propylene glycol or glycerin antifreeze and anti-foam emulsion were added and the obtained mixture was stirred until homogenous suspension is obtained.
3. Anionic stabilizer added (if exist in the composition), and the obtained mixture stirred until homogenous suspension formed.
4. Diamide tech. powder (chlorantraniliprole or cyantraniliprole) was added to the previously prepared mixture with high shearing until homogenous dispersion is obtained.
5. Optionally, additional active (e.g. chlorfenapyr) tech. powder was added to the previously prepared mixture with high shearing until homogenous dispersion is obtained.
6. The homogenous dispersion as previously prepared was milled until particle size range d90<15 μm obtained.
7. Adjuvant added (if exist in the composition), and the obtained mixture stirred until homogenous suspension formed
8. Proxel™ GXL, Xanthan Gum solution AG RH 23 (2% w/w) and the processing soft water were added, and the final composition was mixed until homogenous dispersion is obtained.

### Physical Stability Analysis of Compositions of Invention:

Selected inventive compositions as represented in Examples 1 and 2 were tested for physical stability using the following parameters:

Phase separation of agrochemical compositions was estimated by measuring the height of the phases in the tested sample.

Viscosity was measured according to CIPAC method MT192 “Viscosity Of Liquids By Rotational Viscometry”. The measurement was carried out using a Brookfield viscosity meter using a spindle 62, 12 rpm and 25° C. During the test the temperature of the liquid sample was kept constant.

Particle Size distribution (PSD) was tested by laser diffraction technique using Particle size analyzer based on laser diffraction: Coulter LS 13320 and Malvern Mastersizer 3000.

The outlined method based on measuring light scattering patterns formed as the laser beam passes through the dispersed particulate sample. The scattering values were translated to particle size distribution using common optical model and mathematical analysis.

Suspensibility of the tested samples was tested according to CIPAC MT 184.1.

This method is intended to determine the suspensibility which is defined as the percentage of one or more active ingredient(s) remaining in suspension after a given time.

Wet Sieve residue was determined according to CIPAC MT 185.

The corresponding stability results are summarized in the Tables 4-6 below.

TABLE 4
Stability test of Cyantraniliprole compositions #3-#6. (54° C. for 14 days)

| | Comp. #3 | | Comp. #4 | | Comp. #5 | | Comp. # 6 | |
|---|---|---|---|---|---|---|---|---|
| | Temperature | | | | | | | |
| Specifications | RT | 54° C. | RT | 54° C. | RT | 54° C. | RT | 54° C. |
| Phase separation | <2% | <2% | <2% | <2% | <2% | <2% | <2% | <2% |
| Viscosity [cP] | 1620 | 1940 | 1620 | 1940 | 2050 | 2150 | 1800 | 2200 |
| PSD D90 [mμ] | 1.6 | 1.7 | 2 | 2.15 | 1.48 | 1.49 | 5.1 | 5.0 |
| Suspensibility | 100.1 | 100 | 100.2 | 99.7 | 98.5 | 99.2 | 98.0 | 99.0 |
| Wet Sieve Residue | <0.1% | <0.1% | <0.1% | <0.1% | <0.1% | <0.1% | <0.1% | <0.1% |
| 75μ filter [%] | | | | | | | | |

TABLE 5
Stability test of Cyantraniliprole composition prepared with different particle sizes

| | composition #12 | | composition #12 | | composition #13 | | composition #13 | | composition #13 | |
|---|---|---|---|---|---|---|---|---|---|---|
| | initial D90 - 2.8μ | | Initial D90 - 12μ | | Initial D90-2μ | | Initial D90 - 6.5μ | | Initial D90-12μ | |
| | Temperature | | | | | | | | | |
| Specifications | RT | 54° C. | RT | 54° C. | RT | 54° C. | RT | 54° C. | RT | 54° C. |
| Phase | <2% | <2% | <2% | <2% | <2% | <2% | <2% | <2% | <2% | <2% |
| Separation | | | | | | | | | | |
| Viscosity [cP] | 1580 | 1780 | 1260 | 1360 | 1250 | 1720 | 1400 | 1400 | 1180 | 1160 |
| PSD D90 [mμ] | 2.9 | 2.8 | 12.3 | 10.8 | 2.1 | 2.1 | 6.5 | 6.7 | 12.4 | 11.9 |
| Suspensibility | 99.8 | 100.1 | 93.8 | 93.4 | 100.1 | 99.9 | 96.8 | 97.5 | 93.2 | 93.0 |
| Wet Sieve Residue | <0.1% | <0.1% | <0.1% | <0.1% | <0.1% | <0.1% | <0.1% | <0.1% | <0.1% | <0.1% |
| 75μ filter [%] | | | | | | | | | | |

Conclusion: As shown above in Tables 4 and 5, Cyantraniliprole compositions of invention are stable in terms of phase separation, suspensibility and wet sieve residue in a range of particle sizes.

TABLE 6
Stability test for Chlorantraniliprole compositions # 7-#10 (54° C. for 14 days)

| | Com. #7 | | Com. # 8 | | Comp. #9 | | Comp. # 10 | |
|---|---|---|---|---|---|---|---|---|
| | Temperature | | | | | | | |
| Specifications | RT | 54° C. | RT | 54° C. | RT | 54° C. | RT | 54° C. |
| Phase | <2% | <2% | <2% | <2% | <2% | <2% | <2% | <2% |
| separation | | | | | | | | |
| Viscosity [cP] | 2850 | 3160 | 1870 | 1890 | 1760 | 1720 | 1500 | 1610 |
| PSD D90 [mμ] | 5.05 | 6.51 | 8.78 | 15.8 | 4.07 | 6.2 | 16.6 | 22.9 |
| Suspensibility | 98.85 | 109.08 | 98.65 | 98.73 | 101.87 | 100.39 | 98.02 | 96.91 |
| Chlorantraniliprole | | | | | | | | |
| [%] | | | | | | | | |
| Suspensibility | 99.70 | 108.41 | 92.03 | 96.10 | 101.17 | 99.43 | 92.13 | 81.92 |
| Chlorfenapyr [%] | | | | | | | | |
| Wet Sieve Residue | <0.1% | <0.1% | <0.1% | <0.1% | <0.1% | <0.1% | <0.1% | <0.1% |
| 75μ filter [%] | | | | | | | | |

TABLE 7
Stability test for Chlorantraniliprole compositions # 11, #14-#16 (54° C. for 14 days)

| | Comp.#11 | | Comp.# 14 | | Comp.# 15 | | Comp.# 16 | |
|---|---|---|---|---|---|---|---|---|
| | Temperature | | | | | | | |
| Specifications | RT | 54° C. | RT | 54° C. | RT | 54° C. | RT | 54° C. |
| Phase separation | <2% | <2% | <2% | <2% | <2% | <2% | <2% | <2%. |
| Viscosity [cP] | 1720 | 1720 | 2020 | 2050 | 1460 | 1320 | 1320 | 1570 |
| PSD D90 [mμ] | 15 | 18 | 4.88 | 11.9 | 13 | 16.6 | 17.2 | 20.7 |
| Suspensibility | 102.03 | 102.08 | 99.26 | 97.72 | 98.83 | 99.05 | 94.66 | 98.61 |
| Chlorantraniliprole | | | | | | | | |
| [%] | | | | | | | | |
| Suspensibility | 102.16 | 101.62 | 96.94 | 92.75 | 99.64 | 98.2 | 79.52 | 97.08 |
| Chlorfenapyr [%] | | | | | | | | |
| Wet Sieve Residue | <0.1% | <0.1% | <0.1% | <0.1% | <0.1% | <0.1% | <0.1% | <0.1% |
| 75μ filter [%] | | | | | | | | |

### Conclusions:

As shown above in Tables 6 and 7, Chlorantraniliprole compositions of invention are stable in terms of phase separation, suspensibility and wet sieve residue in a range of particle sizes.

### Example 3: Evaluation of Insecticidal Activity of Different Compositions Comprising Chlorantraniliprole and Cyantraniliprole on S. littoralis Control

### Materials and Methods

Cotton plants (Pima variety) were grown individually in pots at the greenhouse (20-25° C., RH ^{~}50%) for four weeks. After four weeks period, cotton plants were sprayed according to the treatment lists below (Table 1 and 2) for the composition containing Chlorantraniliprole (CTPR)+Chlorfenapyr (CHL) mixture and Cyantraniliprole (CYNT), respectively. Each treatment was sprayed on at least five cotton plants through automized sprayer with standard spray volume of 200 liters/hectare, in order to provide a good foliage coverage. Each plant was considered a replication in each treatment.

Twenty-four hours after treatment, all plants were infested with 10 2^{nd} instar S. littoralis larvae and kept in growth chambers at constant temperature (25-27° C.), humidity (60±10%) and light conditions (16:8, light/dark) for three days. Larval mortality and leaf damage assessments were performed after three days incubation period.

TABLE 8
List of insecticidal treatments comprising Chlorantraniliprole and
sprayed on cotton plants for S. littoralis mortality assessment.

| | | | | | Sprayed |
|---|---|---|---|---|---|
| | Treatments | Insecticidal Active | Active Ingredient | Formulation | concentration |
| | (Formulated products) | Ingredient | concentration (g/L) | Type | (ppm) |
| 1 | Untreated Check | — | — | — | — |
| 2 | Coragen ®(FMC) | Chlorantraniliprole | 200 | SC | 1 |
| 3 | Pirate (BASF) | Chlorfenapyr | 240 | SC | 7.2 |
| 4 | Coragen ® + Pirate (tank | Chlorantranilliprole + | 200 | SC | 1 |
| | mix) | Chlorfenapyr | 240 | SC | 7.2 |
| 5 | Chlorantraniliprole + | Chlorantranilliprole + | 25 | SC | 1 |
| | Chlorfenapyr (composition | Chlorfenapyr | 180 | | 7.2 |
| | #14) | | | | |

TABLE 9
List of insecticidal treatments containing Cyantraniliprole and sprayed
on cotton plants for S. littoralis mortality assessment.

| | | | | | Sprayed |
|---|---|---|---|---|---|
| | Treatments | Insecticidal Active | Active Ingredient | Formulation | concentration |
| | (Formulated products) | Ingredient | concentration (g/L) | Type | (ppm) |
| 1 | Untreated Check | — | — | — | — |
| 2 | Verimark ®(FMC) | Cyantraniliprole | 200 | SC | 1 |
| 3 | Cyantraniliprole (composition | Cyantraniliprole | 300 | SC | 1 |
| | #13) | | | | |
| 4 | Cyantraniliprole (composition | Cyantraniliprole | 400 | SC | 1 |
| | #17) | | | | |

### Results and Discussion

Insecticidal activity of different compositions comprising whether Chlorantraniliprole or Cyantraniliprole is presented below.

In the first study, the insect mortality was significantly different among treatments. Active ingredients, Chlorantraniliprole and Chlorfenapyr, when tested isolate provided 22% and 0% of control, respectively. The low mortality levels observed in this study was due to the low concentrations previously defined for these studies, which also in preliminary results provided low mortality from 0 to 30%. The combination of both active ingredients in tank mix provided 33.2% of larval mortality, statistically higher than untreated check and Chlorfenapyr treatments, however statistically equal to Chlorantraniliprole treatment.

The combination of Chlorantraniliprole and Chlorfenapyr within composition #14 provided 76.5% larval mortality, statistically higher than all insecticidal treatments and untreated check.

Insecticidal efficacy (%) of different Chlorantraniliprole compositions calculated based on S. littoralis larval mortality assessment three days after larval infestation is represented on FIG. 1.

TABLE 10
Results of statistical analysis performed for larval mortality assessment in Chlorantraniliprole
study (Analysis of variance and Means & Standard deviations).
Analysis of Variance

| Source | DF | Sum of Squares | Mean Square | F ratio | Prob > F |
|---|---|---|---|---|---|
| Treat | 4 | 251.98260 | 62.9957 | 29.9112 | <0.001* |
| Error | 34 | 71.60714 | 2.1061 | | |
| C. total | 38 | 323.58974 | | | |

Means and Std Deviations

| | | | | Std Err | Lower | Upper |
|---|---|---|---|---|---|---|
| Level | Number | Mean | Std Dev | Mean | 95% | 95% |
| UTC | 8 | 9.25 | 1.1649647 | 0.4118772 | 8.2760651 | 10.223935 |
| CTPR 1 ppm | 8 | 7.125 | 2.1671245 | 0.7661942 | 5.3132386 | 8.9367614 |
| CHL 7.2 ppm | 8 | 9.25 | 0.8864053 | 0.3133916 | 8.5089467 | 9.9910533 |
| CTPR 1 + CHL 7.2 ppm | 8 | 6.125 | 0.834523 | 0.2950484 | 5.4273213 | 6.8226787 |
| (tank mix) | | | | | | |
| CTPR 1 + CHL 7.2 ppm | 7 | 2.142857 | 1.7728105 | 0.6700594 | 0.5032809 | 3.7824334 |
| (composition #14) | | | | | | |

In the second study, the insect mortality was also significantly different among treatments. Different compositions comprising Cyantraniliprole provided larval mortality from 38.4 to 74.3% at tested conditions. The lowest number of alive larvae was observed in treatment “composition #13”, with corrected larval mortality calculated as 74.3% through Abbott's equation (data not presented), and statistically different than all other treatments. Second lowest number of alive larvae was observed from treatment “composition #17” with corrected larval mortality calculated as 56.4%, also statistically different than standard commercial composition Verimark® and UTC. Standard Cyantraniliprole composition, commercial product Verimark®, showed highest number of alive larvae in the study, with corrected mortality calculated as 38.4%, also statistically different than the other two Cyantraniliprole compositions.

Insecticidal efficacy of different Cyantraniliprole compositions based on number of S. littoralis alive larvae three days after infestation is represented on FIG. 2.

TABLE 11
Results of statistical analysis performed for larval mortality assessment in Cyantraniliprole
study (Analysis of variance and Means & Standard deviations).
Analysis of Variance

| Source | DF | Sum of Squares | Mean Square | F ratio | Prob > F |
|---|---|---|---|---|---|
| Treat | 3 | 115.25000 | 38.4167 | 31.7931 | <0.001* |
| Error | 12 | 14.50000 | 1.2083 | | |
| C. total | 15 | 129.75000 | | | |

Means and Std Deviations

| | | | | Std Err | Lower | Upper |
|---|---|---|---|---|---|---|
| Level | Number | Mean | Std Dev | Mean | 95% | 95% |
| CYNT 1 ppm (Verimark ®) | 5 | 6 | 1.4142136 | 0.7071068 | 3.7496706 | 8.2503294 |
| CYNT 1 ppm (comp. #17) | 5 | 4.25 | 0.9574271 | 0.4787136 | 2.7265198 | 5.7734802 |
| CYNT 1 ppm (comp. #13) | 5 | 2.5 | 1.2909944 | 0.6454972 | 0.4457397 | 4.5542603 |
| UTC | 5 | 9.75 | 0.5 | 0.25 | 8.9543884 | 10.545612 |

1. An agrochemical suspension concentrate composition comprising:
a) 1.0-40% w/w of diamide compound
b) Sulfosuccinate salt at a concentration from greater than about 0.2 w/w % to about 10 w/w %
c) Nonionic stabilizer at a concentration from greater than about 0.2 w/w % to about 10 w/w %
d) Optionally at least one anionic stabilizer at a concentration from greater than about 0.5 w/w % to about 10 w/w %
e) Water

2. An agrochemical suspension concentrate composition comprising:
a) 1.0-40% w/w of diamide compound
b) Sulfosuccinate salt at a concentration from greater than about 0.2 w/w % to about 10 w/w %
c) Nonionic stabilizer at a concentration from greater than about 0.2 w/w % to about 10 w/w %
d) Anionic stabilizer at a concentration from greater than about 0.5 w/w % to about 10 w/w %
e) Water.

3. An agrochemical suspension concentrate composition according to claim 1 or claim 2 comprising diamide compound at a concentration from about 25.0 w/w % to about 35.0 w/w %.

4. An agrochemical suspension concentrate composition according to claim 1 or claim 2 comprising diamide compound at a concentration from about 10 w/w % to about 20 w/w %.

5. An agrochemical suspension concentrate composition according to claim 1 or claim 2 comprising diamide compound at a concentration from about 1.0 w/w % to about 10 w/w %.

6. An agrochemical suspension according to claim 1 or claim 2 wherein the diamide compound is selected from chlorantraniliprole, cyantraniliprole, tetrachlorantraniliprole, bromoantraniliprole, dichlorantraniliprole, tetraniliprole, cyclaniliprole, cyhalodiamide, flubendiamide, and combinations thereof.

7. The composition of claim 1 or claim 2, wherein the diamide is chlorantraniliprole.

8. The composition of claim 1 or claim 2, wherein the diamide is cyantraniliprole.

9. The composition of claims 1 to 8 wherein the weight ratio of sulfosuccinate salt to the nonionic stabilizer is from about 1:15 to about 15:1.

10. The composition of any of claims 1 to 9, wherein the composition further comprises an additional pesticidal active ingredient selected from chlorfenapyr, novaluron, methoxyfenozide, flumipirin.

11. The composition of any of claim 1 or 2, wherein the anionic stabilizer is selected from naphthalene sulfonate derivatives, lignosulfonate derivatives, polycarboxylates, fatty alcohol phosphate esters, aryl phenol alkoxylate phosphate esters, aryl phenol alkoxylate sulfate esters, salts of vinyl ether polymers and the mixtures thereof.

12. The composition of claims 1 to 11 wherein the weight ratio of sulfosuccinate salt to the anionic stabilizer is from about 1:15 to about 15:1.

13. The composition of claims 1 to 11 wherein the weight ratio of diamide compound to sulfosuccinate salt is from about 1:1 to about 35:1.

14. The composition of claims 1 to 11 wherein the nonionic stabilizer is selected from EO-PO block copolymers, acrylate copolymers, styrene (meth)acrylic copolymers, poloxamers, fatty alcohol alkoxylates and the mixtures thereof.

15. An agrochemical suspension concentrate composition of claims 1 to 14, wherein the volume mean diameter of the solid particles present in the suspension is less than 15 μm.

16. A method for controlling an arthropod pest, comprising diluting a suspension concentrate composition according to any one of claims 1-15 with water, and optionally adding an adjuvant to form a diluted composition, and contacting the insect and/or mite pest or its environment with an effective amount of said diluted composition.

17. A method for the protection of plant propagation material from the attack by insect and/or mite pest, comprising treating the propagation material or the site where the propagation material is to be planted with an effective amount of a composition according to any one of claims 1-15.
